(19) United States
(12) Patent Application Publication
(10) Pub. No.: US 2014/0289247 A1
(43) Pub. Date: Sep. 25, 2014

(54) ANNOTATION SEARCH APPARATUS AND METHOD

(71) Applicant: KABUSHIKI KAISHA TOSHIBA, Tokyo (JP)

(72) Inventors: Masayuki Okamoto, Kawasaki-shi (JP); Masaru Suzuki, Kawasaki-shi (JP); Kosei Fume, Kawasaki-shi (JP); Kenta Cho, Kawasaki-shi (JP)

(73) Assignee: KABUSHIKI KAISHA TOSHIBA, Tokyo (JP)

(21) Appl. No.: 14/195,705

(22) Filed: Mar. 3, 2014

(30) Foreign Application Priority Data
Mar. 21, 2013 (JP) 2013-059028

(51) Int. Cl. G06F 17/30

(52) U.S. Cl. CPC G06F 17/30705; G06F 17/30943
USPC 707/737; 707/758

(57) ABSTRACT

According to an embodiment, an annotation search apparatus includes a feature extractor and an annotation search unit. The feature extractor is configured to extract an annotation feature from an input document and an annotation appended by a user to the input document. The annotation search unit is configured to search annotation information items to retrieve at least one of the annotation information items according to an intended purpose of the user, one of the annotation information items corresponding to the input document and including the annotation feature.

### CROSS-REFERENCE TO RELATED APPLICATIONS

This application is based upon and claims the benefit of priority from Japanese Patent Application No. 2013-059028, filed Mar. 21, 2013, the entire contents of which are incorporated herein by reference.

### FIELD

Embodiments described herein relate generally to an annotation search apparatus and method.

### BACKGROUND

Terminal devices such as a PC (Personal Computer) and tablet terminal, which include a pen input interface, provide an annotation function which allows the user to annotate an electronic document (for example, a Web page, electronic book, and the like). According to such environment, the user can easily annotate an electronic document of his or her own interest anytime via a display device and input device which electronically imitate a familiar paper sheet and pen.

An annotation function enables to collect interesting information. However, if a large number annotation information items related to annotated documents are accumulated, when the user performs a job such as document creation by utilizing the annotation information items, it is difficult to find out an annotation information item useful to create that document. For this reason, it is required to allow the user to search for an annotation information item with high availability.

### BRIEF DESCRIPTION OF THE DRAWINGS

FIG. 1 is a block diagram schematically showing an annotation search apparatus according to an embodiment;

FIG. 2 is a flowchart showing a processing sequence executed when the annotation search apparatus shown in FIG. 1 stores an annotation information item;

FIGS. 3A, 3B, 3C, and 3D are views showing examples of annotated documents;

FIG. 4 is a flowchart showing a processing sequence example executed when the annotation search apparatus shown in FIG. 1 searches for an annotation information item;

FIG. 5 is a view showing a correspondence relationship between annotation information items stored in an annotation storage unit shown in FIG. 1 and templates stored in a template storage unit shown in FIG. 1;

FIG. 6 is a view showing an example of a method of changing the display state of annotated documents in response to template selection;

FIG. 7 is a view showing a note edit screen according to an embodiment;

FIGS. 8A, 8B, and 8C are views showing an operation example for an annotated document pasted on a note;

FIGS. 9A and 9B are views showing use examples of annotation information items related to documents having the same layout; and

FIGS. 10A, 10B, and 10C are views for explaining sharing of an annotation information item and a note.

### DETAILED DESCRIPTION

According to an embodiment, an annotation search apparatus includes a feature extractor and an annotation search unit. The feature extractor is configured to extract an annotation feature from an input document and an annotation appended by a user to the input document. The annotation search unit is configured to search annotation information items to retrieve at least one of the annotation information items according to an intended purpose of the user, one of the annotation information items corresponding to the input document and including the annotation feature.

Various embodiments will be described hereinafter with reference to the accompanying drawings.

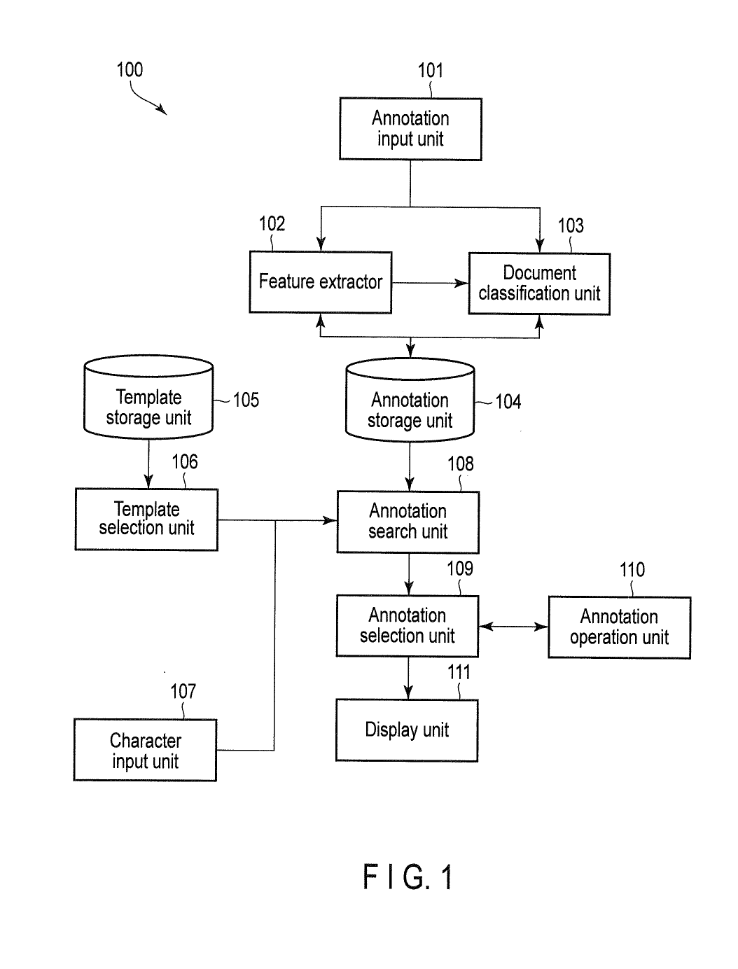

FIG. 1 schematically shows an annotation search apparatus 100 according to an embodiment. The annotation search apparatus 100 is applicable to a terminal apparatus such as a PC, smartphone, tablet terminal, PDA (Personal Digital Assistant), electronic book terminal, and game machine, which include an input interface required to input an annotation. This embodiment assumes a pen input device which allows a handwriting input using a pen. For example, the pen input device includes a touch panel arranged on a display screen of a display device, and a pen used to operate the touch panel.

The annotation search apparatus 100 stores, i.e., accumulates annotation information items to be used later, which are related to annotated electronic documents (to be also simply referred to as documents hereinafter), and searches the accumulated annotation information items for an annotation information item according to a use destination, i.e., a user's intended purpose. Thus, when the user uses an annotation information item, an annotation information item which is useful for the user can be presented.

As an example of annotations according to this embodiment, for example, recorded bookmarks of documents and images of a Web page, electronic book, electronic magazine, and the like, and handwritten annotations such as an enclosing figure, underline, character string (for example, a comment), symbols (for example, ◯, ⋆, etc.), and the like are included. In this embodiment, a document includes, for example, a Web page, electronic book, electronic magazine, and the like, and can include text and images. Note that a document may also be an electronic document which is obtained by reading a paper document (for example, a magazine) using an optical reader such as a camera or scanner, and further undergoing OCR (Optical Character Reader) processing.

As shown in FIG. 1, the annotation search apparatus 100 includes an annotation input unit 101, feature extractor 102, document classification unit 103, annotation storage unit 104, template storage unit 105, template selection unit 106, character input unit 107, annotation search unit 108, annotation selection unit 109, annotation operation unit 110, and display unit 111.

The annotation input unit 101 inputs a document used (for example, browsed or created) by the user and an annotation appended to this document by the user. In this embodiment, the user inputs a desired annotation at a desired position on a document displayed on the display screen using the pen.

The feature extractor 102 extracts an annotation feature from the document and annotation input by the annotation input unit 101. The annotation feature includes an annotation type (for example, an enclosing figure, underline, or character string), an object to which an annotation is appended (for example, text, an image, or an entire document), and a position where an annotation is appended in a document (for example, the coordinates of a document as a whole, coordinates on the display screen, line number, paragraph number, or XPath). An object to which an annotation is appended will also be referred to as an annotated object hereinafter.

The document classification unit 103 classifies the input document to a category of predetermined categories, based on the contents of the entire document and annotated object. Alternatively, the document classification unit 103 classifies, based on the contents of the entire document and annotated object, the input document into a cluster of clusters determined based on a set of annotation information items stored in the annotation storage unit 104.

The annotation storage unit 104 stores annotation information items. Each annotation information item includes the document and annotation input by the annotation input unit 101, the annotation feature extracted by the feature extractor 102, and the category or cluster of the input document classified by the document classification unit 103.

The template storage unit 105 stores one or more templates (patterns or formats) for a document generated by the user using an annotation information item. A document generated by the user using an annotation information item will be referred to as a note hereinafter.

The template selection unit 106 presents templates stored in the template storage unit 105 so as to allow the user to select a template. More specifically, the user selects a desired one of templates presented by the template selection unit 106 using, for example, the pen, and the template selection unit 106 receives a user operation for selecting the template.

The character input unit 107 receives an input from the user with respect to a note. In this embodiment, the user can input text to a note using a keyboard and can input handwritten characters and figures on a note using the pen.

The annotation search unit 108 searches the annotation information items stored in the annotation storage unit 104 to retrieve at least one of the annotation information items according to the user's intended purpose. More specifically, the annotation search unit 108 searches the annotation storage unit 104 for available one or more annotation information items based on the type of the template selected by the template selection unit 106 and the input contents from the character input unit 107.

The annotation selection unit 109 presents the annotation information item found by the annotation search unit 108 so as to allow the user to select the annotation information item. In this embodiment, an annotation information item is presented to the user by displaying a document appended with an annotation. A document appended with an annotation will be referred to as an annotated document hereinafter. An annotated document is generated based on the annotation information item, and is displayed. More specifically, an annotated document can be generated from a document and annotation included in an annotation information item. In this case, the user selects a desired annotated document from those presented by the annotation selection unit 109 using the pen. The annotation selection unit 109 receives a user operation for selecting an annotated document.

The annotation operation unit 110 receives a user operation for an annotated document pasted on the note. The display unit 111 displays an annotation information item (more specifically, annotated document) selected by the annotation selection unit 109 on the note.

The annotation input unit 101, feature extractor 102, document classification unit 103, template selection unit 106, character input unit 107, annotation search unit 108, annotation selection unit 109, annotation operation unit 110, and display unit 111 may be implemented by a CPU (Central Processing Unit) and a memory used by the CPU. The annotation storage unit 104 and template storage unit 105 may be implemented by the memory used by the CPU and/or an auxiliary storage device.

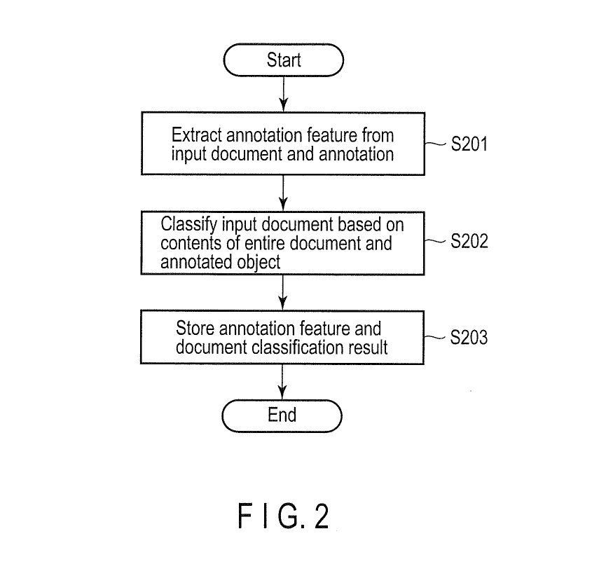

FIG. 2 shows an example of the processing sequence executed when an annotation information item is stored in the annotation storage unit 104 in the annotation search apparatus 100. The user appends an annotation to a document of interest, as needed. In step S201, the feature extractor 102 extracts an annotation feature including an annotation type, annotated object, and annotation position, from the document and the annotation appended to this document. As an example of the annotation type, an enclosing figure, underline, comment, and the like are included. As an example of the annotated object, an image, text, item, entirety, and the like are included. As an example of the position, the coordinates of an entire document, coordinates in the display screen, line number, paragraph number, XPath, and the like are included.

In step S202, the document classification unit 103 classifies the document based on the contents of the entire document and the annotated object. As a classification method, a method of classifying a document to one or more categories of a plurality of predetermined categories (for example, travel, commercial product, health, economy, and book), a method of classifying a document to one or more clusters of a plurality of clusters obtained as a result of clustering of annotation information items already stored in the annotation storage unit 104, and the like can be used. In the former method, the document classification unit 103 identifies a category to which the document belongs using, for example, classifiers such as a support vector machine. In the latter method, the document classification unit 103 classifies the document to a cluster using, for example, hierarchical clustering.

In step S203, an annotation information item including the annotation feature extracted in step S201 and the document classification result obtained in step S202 is stored in the annotation storage unit 104 together with the input document and input annotation.

Note that the annotation information item may also include other information (for example, URL (Uniform Resource Locator)) associated with the input document. Also, the annotation information item may also include an annotated document generated from the input document and input annotation. In this case, the annotation information item need not include the input document and input annotation.

In this manner, the annotation information item associated with the document annotated by the user is stored in the annotation storage unit 104. By repetitively executing the processing shown in FIG. 2, a plurality of annotation information items associated with a plurality of documents are accumulated in the annotation storage unit 104.

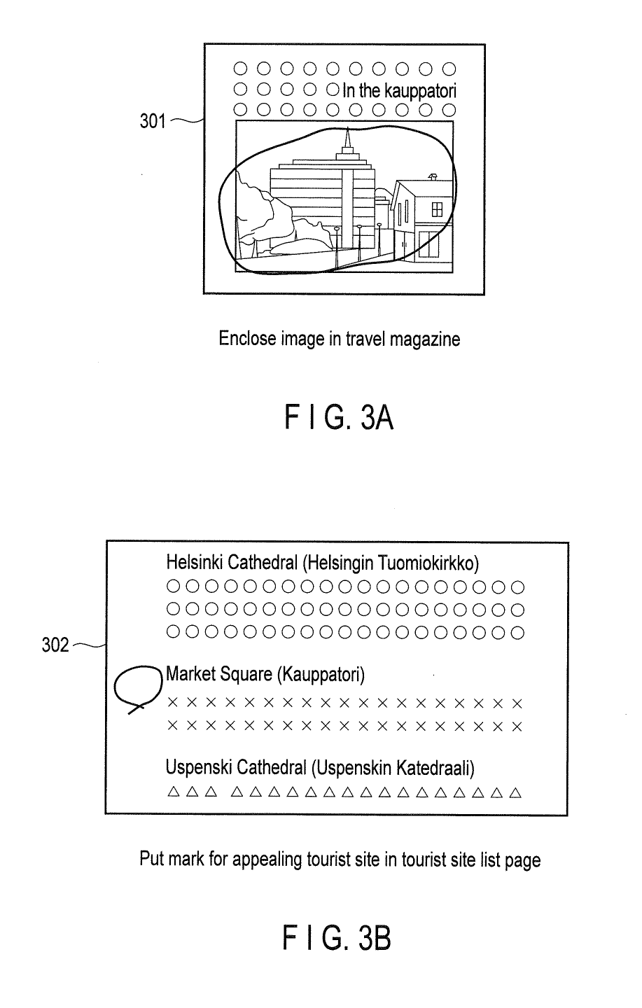

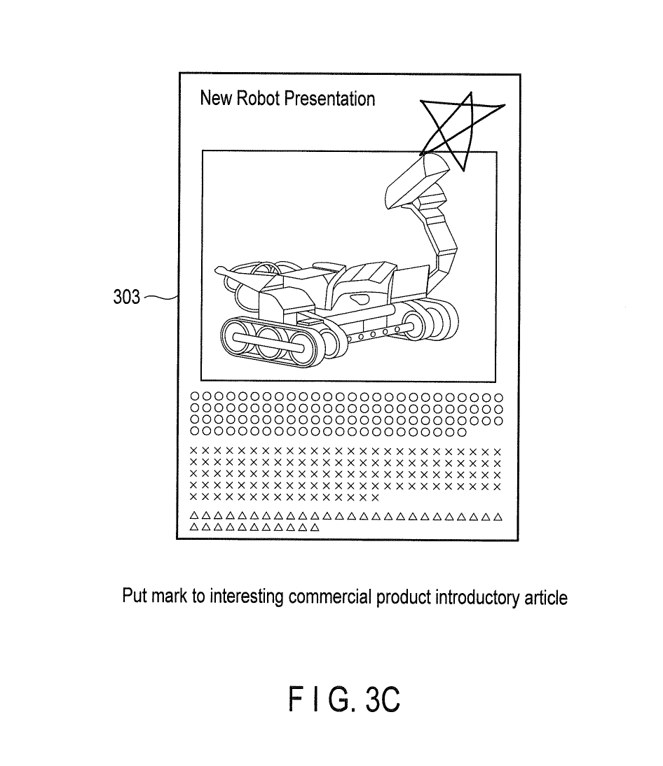

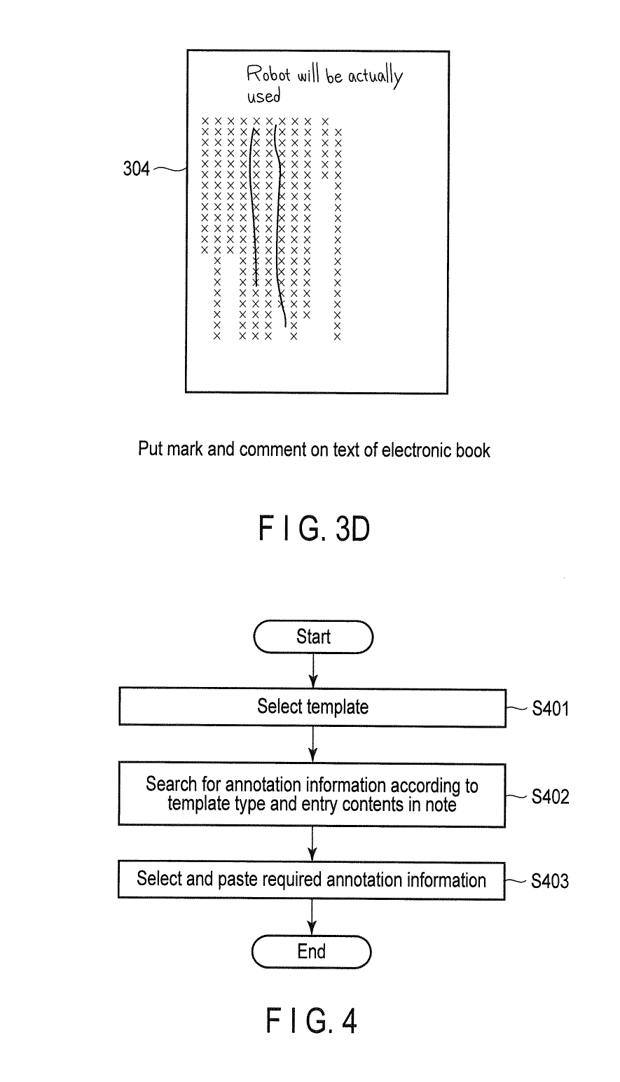

FIGS. 3A, 3B, 3C, and 3D show examples of annotations appended to documents. FIG. 3A shows an example in which the user encloses an image of interest with a line while browsing an electronic magazine associated with travel. FIG. 3B shows an example in which the user appends a mark (◯) to an interesting tourist spot on a Web page which displays a list of tourist spots. FIG. 3C shows an example in which the user appends a mark (⋆) to an interesting product introductory article. FIG. 3D shows an example in which the user appends a mark (underline) to part of an electronic book, and writes a comment “robot will be actually used” to a blank space. Note that the annotations are not limited to those input by handwriting, as shown in FIGS. 3A, 3B, 3C, and 3D. In this embodiment, a bookmark operation, selection with a mouse, and the like can be handled as annotations.

A document 301 shown in FIG. 3A is an electronic magazine associated with travel, and is classified to, for example, a travel category, commercial product category, and book category. A document 302 shown in FIG. 3B is a Web page which displays a list of tourist spots, and is classified to, for example, a travel category. A document 303 shown in FIG. 3C is a product introductory article related to announcement of a new robot model, and is classified to, for example, a commercial product category and book category. A document 304 shown in FIG. 3D is an electronic book including text related to a robot, and is classified to, for example, a commercial product category and book category.

An annotation information item stored in the annotation storage unit 104 by the processing shown in FIG. 2 can be used later as needed. In this embodiment, a note such as a travel note or reading note according to the intended purpose is generated based on a template, as will be described later. At this time, an annotation information item which can be used to generate that note is retrieved (that is, read out) from the annotation storage unit 104, and an annotated document corresponding to the retrieved annotation information item is presented to the user. The user generates a note by, for example, pasting the presented annotated document.

As a presentation method of an annotated document, a method of displaying the entire document, a method of clipping and displaying an annotated object, and the like can be used. For example, when an image is enclosed by a line, as shown in FIG. 3A, the image as an annotated object may be clipped and displayed, or the entire document may be displayed. On the other hand, when an annotation is appended to explanatory text of “Kauppatori”, as shown in FIG. 3B, since it is estimated that the user is interested in “Kauppatori”, a portion including the explanatory text of “Kauppatori” as the annotated object may be displayed. On the other hand, when an annotation is appended to the title of a document, as shown in FIG. 3C, it is estimated that the user is interested in the entire document. In this case, for example, the entire document is displayed. Furthermore, when an underline and comment are appended, as shown in FIG. 3D, the document is entirely or partially displayed so as to display the underline and comment.

FIG. 4 shows an example of the processing sequence when the annotation search apparatus 100 searches for an annotation information item.

Initially, templates stored in the template storage unit 105 are displayed. The user selects a desired template from those displayed by the template selection unit 106 (step S401). As templates, formats which assume intended purposes such as a travel note, commercial product comparison note, reading note, and foodie note are prepared. For example, when a travel note is selected, information items such as a destination to visit, transportation, and souvenir are assumed to be input. Note that the template storage unit 105 may store a template which does not assume any specific intended purpose.

The annotation search unit 108 searches for an annotation information item according to the type of the template selected in step S401 and a user operation for the note (step S402). For example, when the template for a travel note is selected, the annotation search unit 108 determines that a use destination (user's intended purpose) is a travel category based on the type of the selected template, and generates a search query used to search for an annotation information item related to a document classified to the travel category. When the user inputs “Finland” to the note, a search query required to search for an annotation information item related to document including “Finland” in annotated object or around it is generated. When a template for a reading note is selected, a search query required to search for an annotation information item related to document classified to a book category is generated. In this case, the search query is set to preferentially retrieve annotation information items related to documents each appended with an underline and comment of those related to documents classified to the book category. In this manner, the search priority may be set based on the type of the template and the class of the annotation.

When an annotated document corresponding to the retrieved annotation information item is displayed, the user selects that annotated document by the annotation selection unit 109 to paste the selected annotated document to the note (step S403). As a pasting method, a method of simply touching the displayed annotated document with the finger or pen, a method of designating a position to lay out the document by dragging & dropping, and the like are available. When a plurality of annotated documents are selected and laid out, two or more annotated documents can be pasted at the same time. Furthermore, part (for example, a character string or image) of the annotated document can be selected and pasted to (for example, to a memo field in the note).

The annotated document pasted on the note is displayed by the display unit 111. As a display method, a method of displaying a document without changing its size, a method of displaying a document in an enlarged or reduced scale according to the size of a template or a frame in the template, a method of displaying a document by adjusting a marking range in correspondence with a shape of a frame in a template, and the like can be used.

In this embodiment, an annotation information item is displayed to have an appearance when it is annotated intact. That is, the annotated document is displayed. Furthermore, a function of displaying processing results of the feature extractor 102 and document classification unit 103, information of an annotated document, and the like in response to a predetermined operation (“touching”, “double-tapping”, “turning over”, “reading contents described in lower layer by flipping”, etc.) may be included.

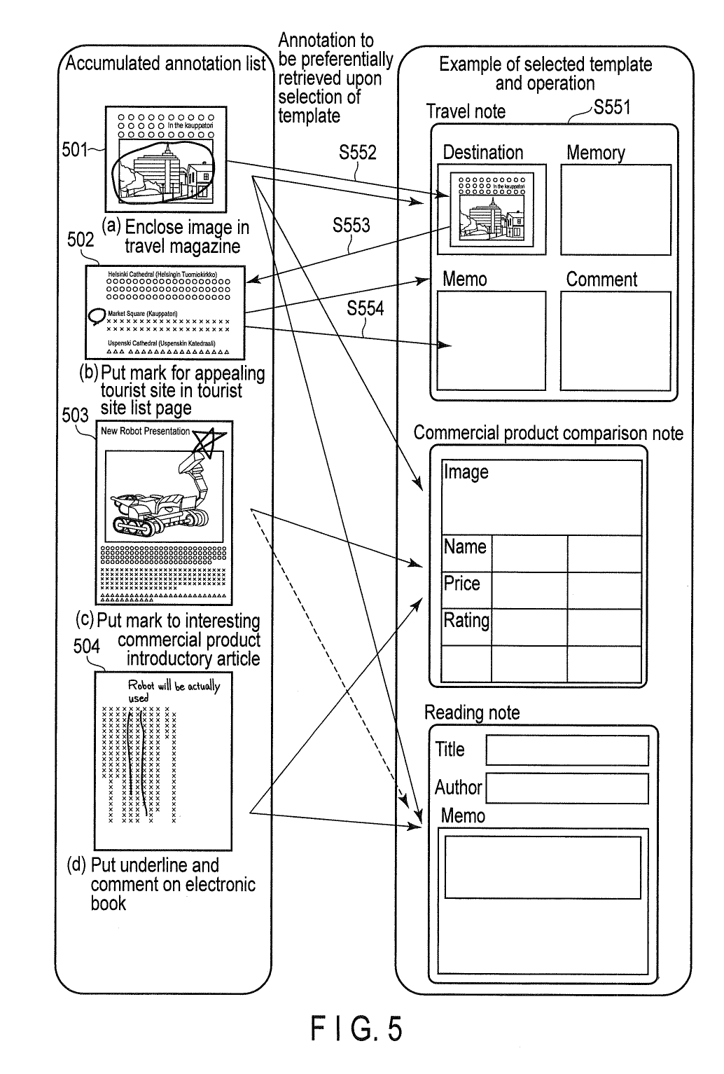

FIG. 5 shows an example of the correspondence relationship between the templates and annotation information items preferentially retrieved according to the types of templates. Annotated documents 501 to 504 in FIG. 5 respectively correspond to the documents 301 to 304 in FIGS. 3A, 3B, 3C, and 3D.

For example, when “travel note” is selected (step S551), annotation information items (more specifically, annotated documents) which are more likely to be pasted on the travel note are displayed in turn. In the example of FIG. 5, a plurality of annotated documents including the annotated documents 501 and 502 are displayed. In this case, when the user makes an operation for selecting the annotated document 501 or that for dragging and dropping the annotated document on the note, the annotated document 501 is pasted and displayed on the travel note (step S552). In FIG. 5, the annotated document 501 is pasted in a field of a destination to visit in the travel note. After that, when the user conducts an annotation information search operation (step S553), other annotations related to the travel note and pasted annotated document are recommended, that is, they are preferentially displayed. When text in the document 501 includes a place name (keyword) “Kauppatori”, even when, for example, a large number of other annotated documents are displayed, since the document 502 includes the place name (keyword) “Kauppatori”, the document 502 is preferentially retrieved and displayed. Also, news articles related to “Kauppatori”, which are not displayed at the time of the first search and the like, are displayed as search results. Subsequently, the user makes an operation for pasting text in the annotated document 502 on a memo field (step S554).

Next, an example upon selection of “reading note” will be described below. In the example of FIG. 5, when “reading note” is selected, the annotated documents 501 and 504 are displayed. In this case, when the user makes an operation for selecting the annotated document 504 or that for dragging and dropping the annotated document 504 on the note, the annotated document 504 is pasted and displayed on the reading note. After that, when the user conducts an annotation information search operation, the annotated document 503 corresponding to a document related to a robot is displayed as a search result based on the character string “robot will be actually used” included in the annotation. In this manner, a search result is updated according to the selected template and input annotation, thus proceeding with generation of a desired note.

Note that the embodiment is not limited to the example in which an annotation information item classified to a category according to the type of the selected template is displayed as an available annotation information item. For example, when the travel note is selected, an annotation information item classified to the travel category may be displayed, and that which is not classified to the travel category, that is, an unavailable annotation information item may be displayed with a low priority order. The annotation information search operation may be automatically executed when a predetermined operation (that for pasting the annotated document on the note or the like) is made, in addition to the search operation explicitly conducted by the user.

As a method of displaying a list of annotated documents, a method of displaying annotated documents in a priority order from that corresponding to annotation information items retrieved preferentially, a method of expressing priority levels by the degrees of emphasis of sizes, colors, or the like, and the like can be used.

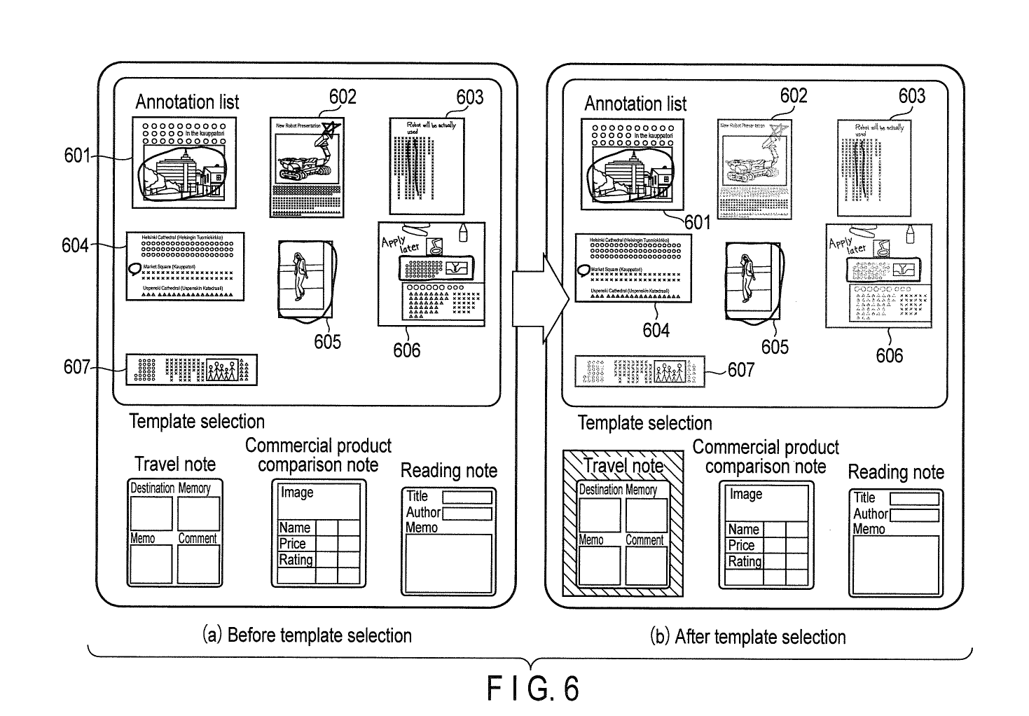

FIG. 6 shows an example of a method of changing a display state of annotated documents upon template selection. (a) of FIG. 6 shows a state in which a list of annotated documents and that of selectable templates are displayed before template selection. When the user selects “travel note” in this state, the display state of annotated documents 601, 604, and 605, which can be pasted on the travel note, is left unchanged, and that of other annotated documents 602, 603, 606, and 607 is changed. The display state is changed by changing an emphasis method such as conversion from color display to grayscale display or reduced-scale display.

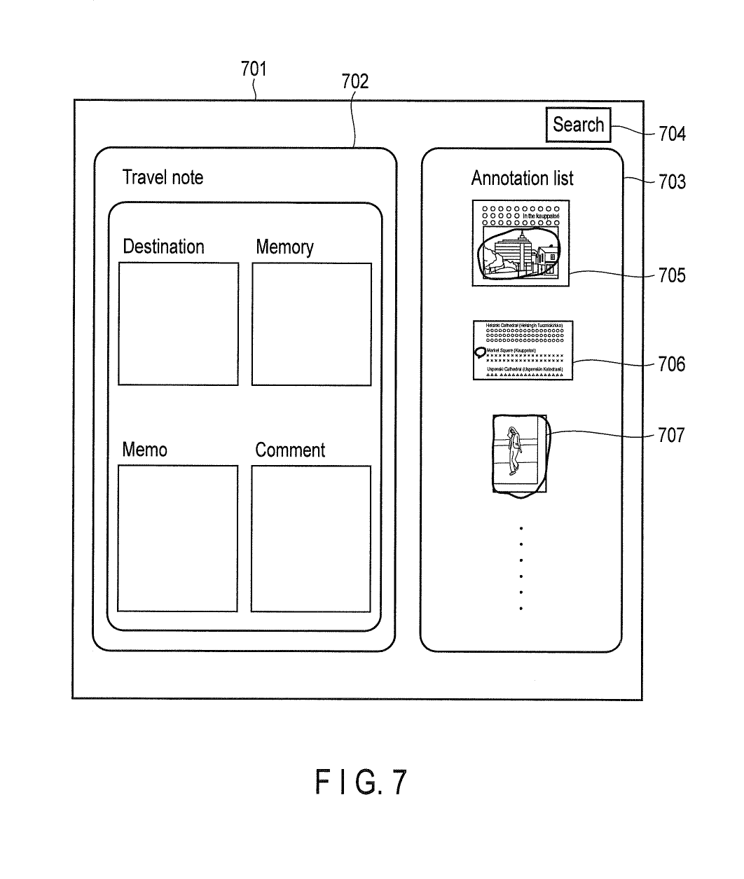

FIG. 7 shows an example of a display screen 701 used to generate and edit a note. More specifically, FIG. 7 shows a state in which the user selects the template for the travel note, and is about to generate the note. The display screen 701 includes a note (travel note in FIG. 7) 702, annotation list 703, and search button 704. On the annotation list 703, retrieved annotated documents 705, 706, and 707 are displayed. The search button 704 is used to conduct an annotation information search. Every time the user presses the search button 704, the search is conducted.

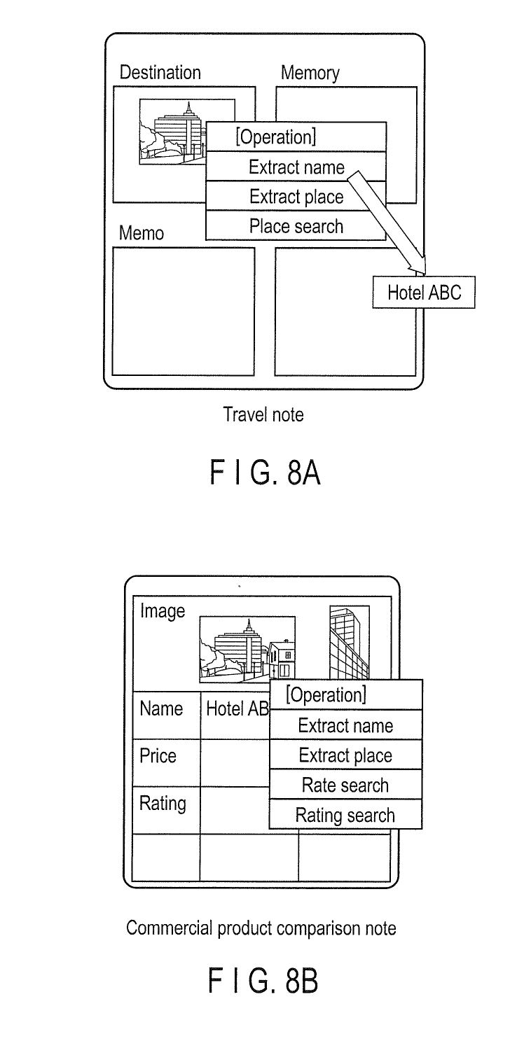

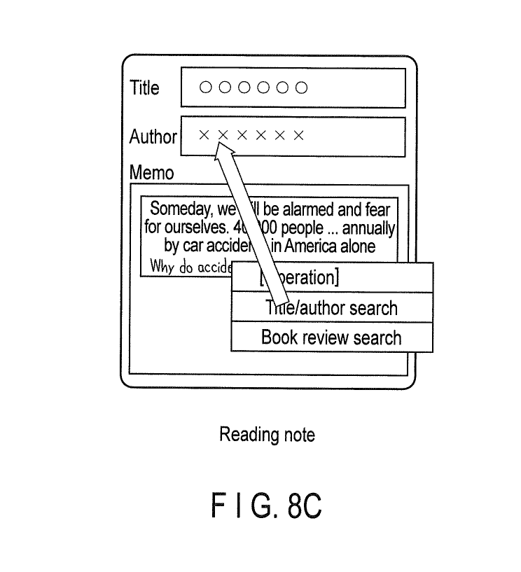

A method of implementing predetermined functions by making predetermined operations on the annotated document pasted on the note will be described below with reference to FIGS. 8A, 8B, and 8C. These operations are input using the annotation input unit 110.

FIGS. 8A, 8B, and 8C show examples in which the user selects an annotated document pasted on a note to open an operation menu and then selects an item in the operation menu to execute a function corresponding to that item. The annotation operation unit 110 presents the operation menu to the user. Operation items in the operation menu can be determined according to the template type. FIG. 8A shows an operation example on an annotated document pasted on a travel note. In FIG. 8A, when the user selects the annotated document using the pen, the operation menu including “extract name”, “extract place”, and “place search” is opened. When the user selects “extract name”, a name candidate (“Hotel ABC” in FIG. 8A) is extracted from the contents of the annotated document or a document included in an annotation information item by a technique such as named entity extraction, and the extracted candidate is displayed. If required information is extracted, the user selects that information.

FIG. 8B shows an operation example on an annotated document pasted on a commercial product comparison note. In this example, when the user selects the annotated document using the pen, an operation menu including “extract name”, “extract place”, “rate search”, and “rating search” is opened. When the user selects “rate search”, rate information is extracted by named entity extraction processing from the contents of the annotated document or a document included in annotation information and/or from search results of external resources such as Webs. When the note includes a “rate” field, the rate information is automatically inserted in that field. Also, the commercial product comparison note may include an item used to extract specs.

FIG. 8C shows an operation example on the reading note. In this example, when the user selects an annotated document using the pen, an operation menu including “title/author search” and “book review search” is opened. When the user selects “title/author search”, a title and author are retrieved based on bibliographic information, and are inserted in predetermined fields in the note. In FIG. 8C, “◯◯◯◯◯◯” is inserted in the title field, and “XXXXXX” is inserted in the author field. On the other hand, when the user selects “book review search”, a review article and comment for the book are retrieved from external resources, and are pasted in a memo field. In this embodiment, such review article and comment are retrieved from the external resources, but they may be retrieved from resources such as annotation information items accumulated by the user himself or herself.

Also, operations for an annotated document may be determined according to the template (that is, note) as a destination where that document is pasted. For example, FIG. 8A shows an example in which an annotated document related to a travel magazine is pasted on the travel note, and operations for extracting a name and place are displayed. When the same annotated document is pasted on “reading note”, operation items for extracting a title, author, and publisher as information of the magazine itself are displayed.

Note that in FIGS. 8A, 8B, and 8C, the user selects all operations such as name extraction. Alternatively, extraction/pasting processing may be automatically executed when the annotated document is pasted on the note. In this case, the user's convenience can be further improved.

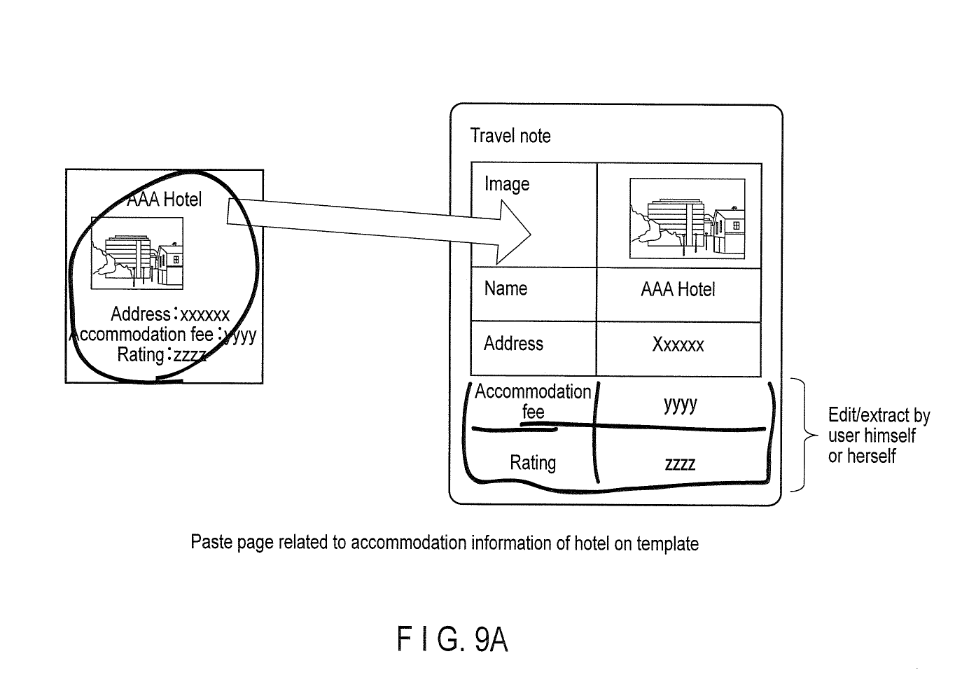

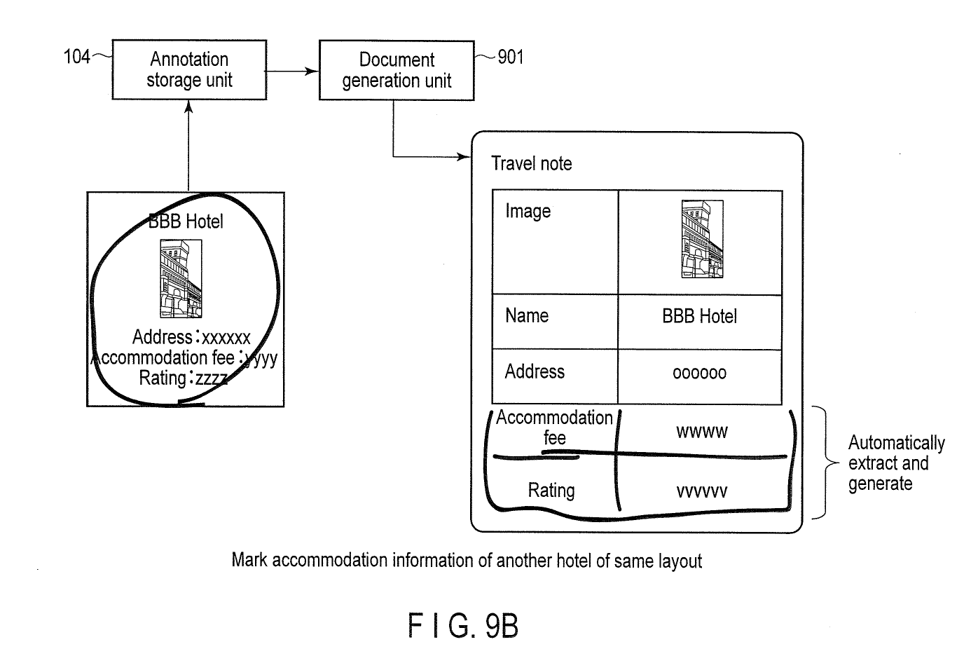

FIGS. 9A and 9B show examples in which an annotation for a Web page of a certain hotel is pasted on a “destination note” template used to organize a destination. FIG. 9A shows a case in which an annotated document related to a Web page of “AAA Hotel” is pasted on a note. Assume that a name and address are automatically extracted, but the user himself or herself fills an accommodation fee and rating in the note, and pastes keywords used for an extraction operation to generate the note. After that, when the user acquires an annotation information item related to a page of “BBB Hotel” described in a Web page having the same layout, the processing having the same contents as “AAA Hotel” is executed, as shown in FIG. 9B. Note that the same layout includes a case including similar character and figure layouts as a result of the OCR processing, or a case including a common HTML tag structure.

The annotation search apparatus 100 can include a document generation unit 901 (shown in FIG. 9B) which automatically generates a document using a newly acquired annotation information item based on a document generation history. More specifically, as shown in FIGS. 9A and 9B, after a note is generated using an annotation information item related to a certain document, when an annotation information item related to another document having the same layout as that of the former document is stored in the annotation storage unit 104, the document generation unit 901 automatically generates a document (note) using the annotation information item related to the other document.

Annotation information items collected by the user and the generated note are browsed by the user himself or herself, and can also be shared by other users. In this case, the user can also make a comment on the shared note of another user.

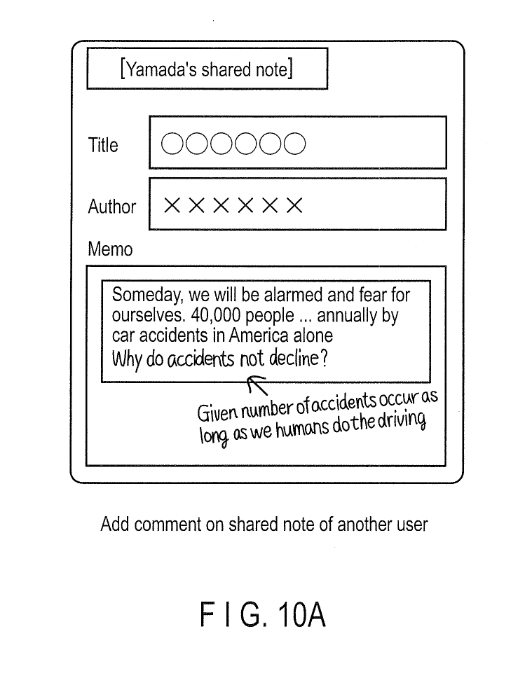

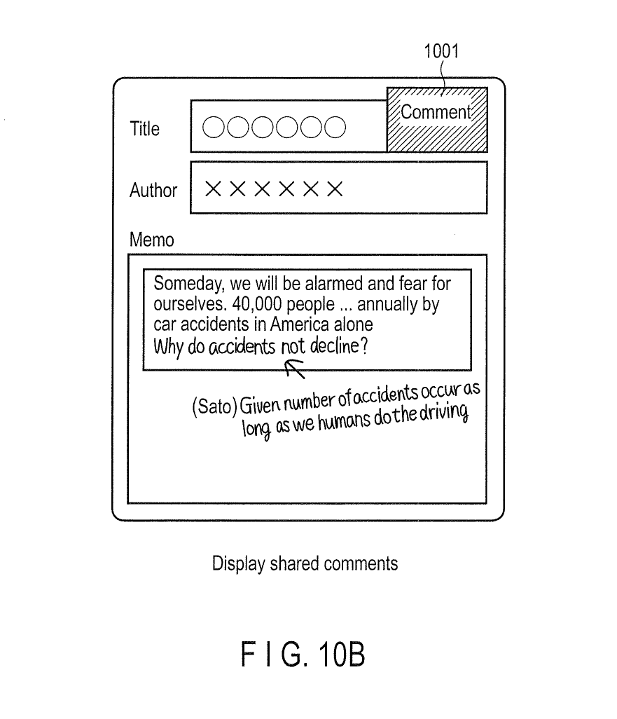

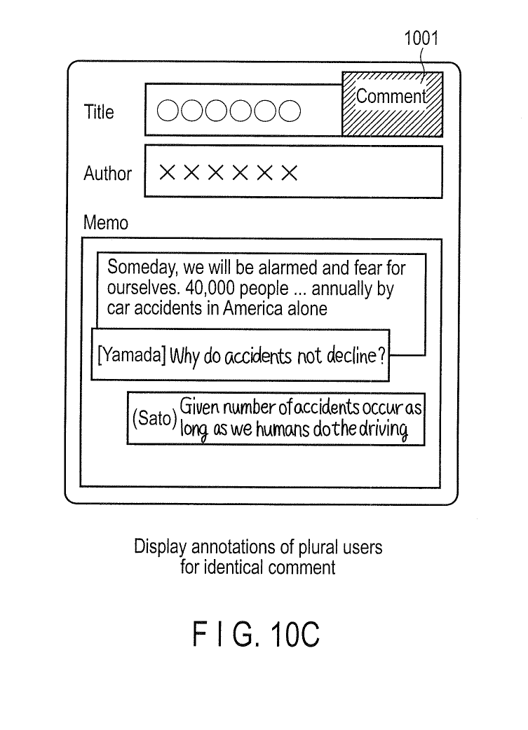

A sharing example of annotation information items and a note will be described below with reference to FIGS. 10A, 10B, and 10C. Assume that when the user executes a “share” operation for his or her own note from the operation menu, that note can be published to other users. A publication range setting indicating to whom the note is to be published, a registration method of other sharable users, and the like use the same mechanism as that of an existing sharing application and service. In the example of FIG. 10A, the user browses a note for which another user has executed the share operation, and additionally writes “a given number of accidents occur as long as we humans do the driving”. As a result, the comment additionally written by another user is superimposed on the screen of the note creator, as shown in FIG. 10B. The addition of a comment by another user can also be confirmed from an indicator 1001. Assume that whether or not to display the indicator 1001 can be separately set. Or, it is possible to share the annotation information item alone. For example, when a plurality of users individually write comments at the same place on the single reading note, as shown in FIG. 10C, annotations of respective users are independently shared and displayed.

The annotation search unit 108 can present an annotation information item generated by another user to the user. The annotation search unit 108 may retrieve an annotation information item by another user for the same document as that corresponding to an annotation information item by the user, and may retrieve an annotation information item corresponding to another document having the same layout as that of the document corresponding to the retrieved annotation information item.

Note that the annotation storage unit 104 need not always be arranged in the annotation search apparatus 100, and may be arranged in another apparatus (for example, a server) which can communicate with the annotation search apparatus 100. With this arrangement, a plurality of users can share an annotation information item.

As described above, the annotation search apparatus according to this embodiment accumulates annotation information items related to documents of the user's interests, and searches the accumulated annotation information items for an annotation information item according to a use destination (user's intended purpose), thus allowing to easily generate a note using the annotation information items. That is, the user can easily retrieve a useful annotation information item. Furthermore, predetermined processing is executed in response to an operation (for example, that using the pen) for a document included in an annotation information item or an annotated document. Thus, the user can execute processing such as keyword extraction and related information search without inputting any keyword using the keyboard. That is, required information can be easily extracted using the contents of an original document (input document).

In the aforementioned example of this embodiment, an annotation information item (annotated document) is presented after template selection. Alternatively, when an annotated document is selected, an available template may be presented.

The annotation search apparatus of this embodiment assumes implementation by a portable hardware apparatus. Alternatively, some functions of the annotation search apparatus of this embodiment may be executed on an external server connected to a network. Also, the annotation search apparatus of this embodiment can be implemented by a general computer which includes a control device such as a CPU, a storage device such as a ROM and RAM, an external storage device such as an HDD, a display device such as a display, and an input device such as a keyboard and mouse.

Instructions in the processing sequences described in the aforementioned embodiment can be executed based on a program as software. A general-purpose computer system stores this program in advance and loads the stored program, thus obtaining the same effects as those by the annotation search apparatus of the aforementioned embodiment. The instructions described in the aforementioned embodiment are recorded, as a program which can be executed by a computer, in a magnetic disk (flexible disk, hard disk, etc.), optical disk (CD-ROM, CD-R, CD-RW, DVD-ROM, DVD±R, DVD±RW, etc.), semiconductor memory, or similar recording medium. The storage format of a recording medium is not particularly limited as long as that recording medium is readable by a computer or embedded system. The computer loads the program from this recording medium, and controls a CPU to execute instructions described in the program based on this program, thus implementing the same operation as the annotation search apparatus of the aforementioned embodiment. Of course, the computer may acquire or load the program via a network.

Also, an OS (Operating System), database management software, MW (middleware) for a network, or the like, which runs on a computer, may execute some of processes required to implement this embodiment based on instructions of a program installed from the recording medium in a computer or embedded system.

Furthermore, the recording medium of this embodiment is not limited to a medium separate from a computer or embedded system, and includes a recording medium, which stores or temporarily stores a program downloaded via a LAN, the Internet, or the like.

The number of recording media is not limited to one, and the recording medium of this embodiment includes the case in which the processing of this embodiment is executed from a plurality of media. That is, the medium configuration is not particularly limited.

Note that the computer or embedded system of this embodiment is used to execute respective processes of this embodiment based on the program stored in the recording medium, and may have an arbitrary arrangement such as a single apparatus (for example, a personal computer, microcomputer, etc.), or a system in which a plurality of apparatuses are connected via a network.

The computer of this embodiment is not limited to a personal computer, and includes an arithmetic processing device, microcomputer, or the like included in an information processing apparatus, and is a generic name of a device and apparatus, which can implement the functions of this embodiment based on the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An annotation search apparatus comprising:
a feature extractor configured to extract an annotation feature from an input document and an annotation appended by a user to the input document; and
an annotation search unit configured to search annotation information items to retrieve at least one of the annotation information items according to an intended purpose of the user, one of the annotation information items corresponding to the input document and including the annotation feature.

2. The apparatus according to claim 1, further comprising a template selection unit configured to receive an operation for selecting a template from one or more templates which are prepared in advance,
wherein the annotation search unit determines the intended purpose of the user based on the selected template.

3. The apparatus according to claim 1, wherein the annotation feature includes a type, an object, and a position of the annotation, and the annotation information item includes the input document, the annotation, the annotation feature, and a category or a cluster of the input document.

4. The apparatus according to claim 1, further comprising an annotation operation unit configured to receive an operation for an annotated document presented based on the retrieved annotation information item.

5. The apparatus according to claim 4, wherein the annotation operation unit determines an operation item to be presented to the user according to the selected template.

6. The apparatus according to claim 4, wherein the annotation operation unit provides an operation item determined according to the selected template to an annotated document pasted on the selected template.

7. The apparatus according to claim 1, wherein the annotation search unit generates a search query to retrieve at least one of an annotation information item by another user for a same document as a document to which an annotation is appended by the user and an annotation information item corresponding to another document having a same layout as a document corresponding to the retrieved annotation information item.

8. The apparatus according to claim 1, wherein the annotation information items are shared by another user, and at least one of the annotation information items includes an annotation appended by the user and an annotation appended by the other user.

9. The apparatus according to claim 1, further comprising a document generation unit configured to generate a document using an annotation information item related to a document having a same layout as a document corresponding to an already used annotation information item based on a document generation history.

10. An annotation search method comprising:
extracting an annotation feature from an input document and an annotation appended by a user to the input document; and
searching annotation information items to retrieve an annotation information item according to an intended purpose of the user, one of the annotation information items corresponding to the input document and including the annotation feature.

11. The method according to claim 10, further comprising receiving an operation for selecting a template from one or more templates which are prepared in advance,
wherein the searching comprises determining the intended purpose of the user based on the selected template.

12. The method according to claim 10, wherein the annotation feature includes a type, an object, and a position of the annotation, and the annotation information item includes the input document, the annotation, the annotation feature, and a category or a cluster of the input document.

13. The method according to claim 10, further comprising receiving an operation for an annotated document presented based on the retrieved annotation information item.

14. The method according to claim 13, wherein the receiving comprises determining an operation item to be presented to the user according to the selected template.

15. The method according to claim 13, wherein the receiving comprises providing an operation item determined according to the selected template to an annotated document pasted on the selected template.

16. The method according to claim 10, wherein the searching comprises generating a search query to retrieve at least one of an annotation information item by another user for a same document as a document to which an annotation is appended by the user and an annotation information item corresponding to another document having a same layout as a document corresponding to the retrieved annotation information item.

17. The method according to claim 10, wherein the annotation information items are shared by another user, and at least one of the annotation information items includes an annotation appended by the user and an annotation appended by the other user.

18. The method according to claim 10, further comprising generating a document using an annotation information item related to a document having a same layout as a document corresponding to an already used annotation information item based on a document generation history.

19. A non-transitory computer readable medium including computer executable instructions, wherein the instructions, when executed by a processor, cause the processor to perform a method comprising:
extracting an annotation feature from an input document and an annotation appended by a user to the input document; and
searching annotation information items to retrieve an annotation information item according to an intended purpose of the user, one of the annotation information items corresponding to the input document and including the annotation feature.
